(19) United States
(12) Patent Application Publication
(10) Pub. No.: US 2008/0074101 A1
(43) Pub. Date: Mar. 27, 2008

(54) Flat Displacement or Position Sensor

(76) Inventors: Daniel Dobler, Rankweil (AT); Alexander Moosmann, Dornbirn (AT)

Correspondence Address: K.F. ROSS P.C., 5683 RIVERDALE AVENUE, SUITE 203 BOX 900, BRONX, NY, 10471-0900, US

(21) Appl. No.: 11/662,043

(22) PCT Filed: Sep. 5, 2005
(86) PCT No.: PCT/EP05/09520

§ 371 Date: Mar. 5, 2007

(30) Foreign Application Priority Data
Sep. 6, 2004 (DE) 10 2004 043 457.3
Sep. 2, 2005 (DE) 10 2005 042 050.8

(51) Int. Cl. G01B 7/14

(52) U.S. Cl. 324/207.2

(57) ABSTRACT

The invention relates to a sensor (1) for detecting a linear or rotative displacement of an object. According to the invention, a sensor element (2) can be fastened to the object or forms part of the object, said element interacting with at least one detection element (3). The sensor is characterised in that two detection elements (6, 7) are located on one displacement plane adjacent to a magnet (4) that generates a magnetic field and that the sensor element (2′) consists of a material that influences the magnetic field.

The invention relates to a sensor assembly for detecting a linear or rotary movement of an object according to the features of the preamble of claim 1.

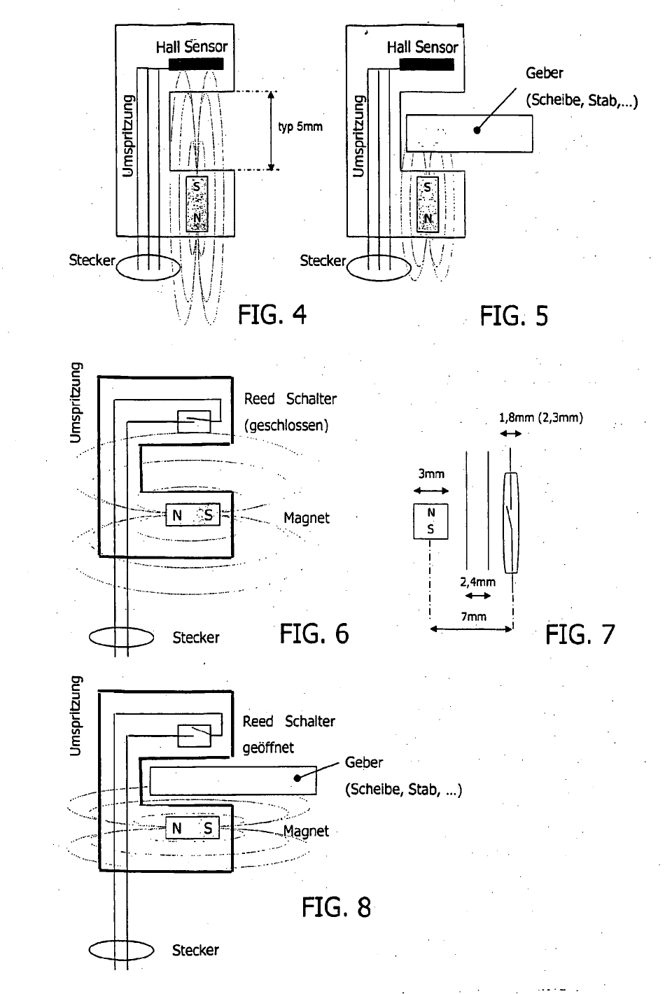

Various sensor assemblies are known for detecting linear or rotary movements of an object in a contactless and therefore wear-free manner. These sensor assemblies operate using a permanent magnet whose magnetic field is influenced by a detection element that can be fastened to the object or that forms part of the object. The magnetic field acts on a detector that is designed either as a Hall sensor (illustrated in FIGS. 4 and 5) or as a reed switch (illustrated in FIGS. 6 through 8).

In the sensor assembly illustrated in FIGS. 4 and 5, the Hall sensor and the permanent magnet (S: south pole and N: north pole of the permanent magnet) are positioned perpendicular to one plane of movement of the detection element, so that the sensor assembly has a U-shaped cross section overall. The detectors are provided with an extrusion coating for protection, and leading out therefrom are cables for the Hall sensor that have a plug on the end. By moving the detection element in or out of the U-shaped sensor a connection may be made at a given position; i.e., a linear displacement may be measured in which larger distances between the detection element and the sensor assembly are also possible. However, this approach also has disadvantages: It is costly compared to reed switches, requires additional components for EMI or ESD protection, requires polarity reversal protection, requires that polarity be maintained when installing the permanent magnet, requires up to three connections, and has an output signal that is severely limited by the reliable supply voltage from the Hall sensor.

On the other hand, there are approaches involving a sensor assembly having only one reed switch, as illustrated in FIGS. 6 through 8. Here as well, the sensor assembly (the housing thereof) has a U-shaped cross section and is provided with an extrusion coating. By moving the detection element in or out of the U-shaped sensor the reed switch is closed (when the detection element is spaced from the sensor assembly) or opened (when the detection element is juxtaposed with and inside the sensor assembly). Compared to the approach using Hall sensors, this approach using reed switches is much simpler, since the reed switch operates according to a simple principle and requires only two connections and no EMI or ESD protective elements. In addition, polarity reversal protection is not necessary, so that during manufacture of the sensor assembly there is also no need to take the polarity of the permanent magnet into account. The output signal may typically be between 0 and 24 volts, optionally up to 100 volts, simple signal matching being also possible under this principle. Signal matching may be performed, for example, by appropriate connection to other components, such as two resistors.

Although the sensor assembly approach based on the reed switch principle is simpler compared to the principle employing a Hall sensor, the former approach also has disadvantages. Because of the simple principle of the reed switch, the movement of the object cannot be detected in a stepless or stepped manner. Only a single conclusion may be drawn, namely, whether the object is located in one given position (reed switch open) or in another position (reed switch closed), corresponding to a proximity detector. Furthermore, under the principles of both the known approaches there is the risk that contaminants may collect in the cavity of the U-shaped housing and, in particular for magnetically conductive particles that may be attracted due to the magnetic pull of the permanent magnet. If, depending on its size, this recess becomes clogged with a large accumulation of contaminant particles, the detection element may no longer be able to enter the recess, thereby preventing movement of the object from being measured. This may occur in short order when the sensor assembly is in continuous use and exposed to severe environmental conditions.

The object of the invention, therefore, is to provide a sensor assembly for detecting the movement of an object that avoids the above-described disadvantages. In particular, a sensor assembly is intended that allows specific positions of the object to be scanned. The predetermined positions may result from linear or rotary movement. The aim is to avoid providing the detection element with an additional magnetic component such as a permanent magnet, a ferrite part, or the like, while continuing to allow a contactless, wear-free measurement.

This object is achieved by the features of claim 1.

According to the invention, at least one or multiple detection elements extend in one plane of movement next to at least one magnetic element that generates a magnetic field, and the detection element is composed of a material that influences the magnetic field., Such a system has several advantages:

First, two detectors—such as reed switches, Hall sensors, magnetic resonance sensor assemblies, or the like—are used that operate in a contactless and therefore wear-free manner. The use of reed switches is particularly preferred since they are reliable and especially economical. The detection element itself is composed of a material that influences the magnetic field of the magnetic element and thus in turn acts on the detectors. The presence of two detectors has the advantage that either a stepless detection of the movement of the object (by use of Hall magnetic resonance sensor assemblies) or a stepped detection of the position of the object (by use of reed switches) may be performed. The magnetic element that generates a magnetic field is still a permanent magnet that is economical and easy to handle. Alternatively or additionally, the magnetic element may be an electromagnet.

A very significant advantage of the invention is that the detectors together with the magnetic element extend in parallel to the plane of movement. The entire sensor assembly may thus have a flat shape and be adapted to the direction of movement of the object. In other words, the detectors together with the magnetic element may have, for example, a flat shape for straight-line movement of the object, or a curved shape for rotary movement of the object. This flat or curved shape in addition to a movement of the detection element past the detectors results in the advantage that no contaminants can collect, in particular in the region of the magnetic element, but also in the entire region of the sensor assembly, which would impair the movement of the detection element. In fact, just the opposite is the case, since dirt particles and contaminants may be removed by the passage of the detection element relative to the detectors.

In a further embodiment of the invention, for detection of a straight-line movement of the object, the detectors and the magnetic element are each mounted on a flat support, and are protected from outside influences by means of a casing. The advantage of the enclosed shape is that no contaminants, in particular shavings or other electrically and magnetically conductive particles, can enter the magnetic field between the detector, in particular the reed switch, and the magnetic element, in particular the permanent magnet. These contaminants may collect most heavily on the surface of the casing in the immediate vicinity of the magnetic element, and are removed when the detection element passes over it. This shape also makes an extremely flat sensor assembly possible, particularly when the detection element also has a flat shape and the detection element and sensor can move relative to each other parallel to a movement plane or in respective parallel planes. The sensor assembly according to the invention has general applicability anywhere a path must be followed and specific positions detected. The sensor assembly is used for recognizing intermediate positions during travel, as well as for determining end positions.

Thus, straight-line movement (position expressed in millimeters, for example) may be scanned in exactly the same manner as for rotary movement (angles expressed in degrees). Use of the sensor assembly in the field of automotive engineering (automobiles) is particularly advantageous, since in this case severe environmental conditions (specifically, contamination from electrically and magnetically conductive particles, temperature fluctuations, vibrations, and the like) are present, and very little installation space is available.

One illustrated embodiment, to which the invention, however, is not limited, is explained below and with reference to the figures, which show the following:

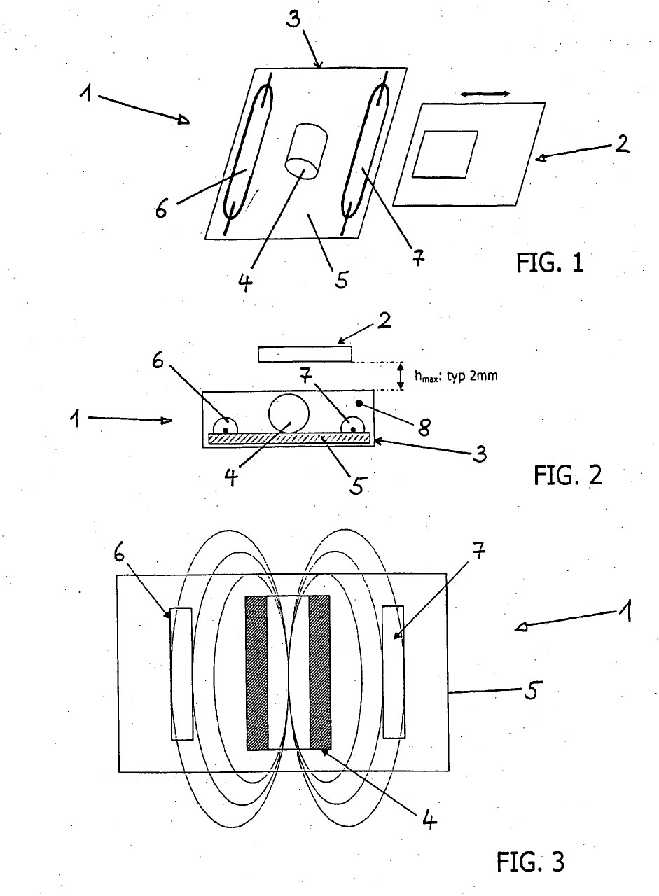

FIGS. 1 and 2 show a sensor assembly according to the invention;

FIG. 3 shows a sensor assembly having an electromagnet; and

FIGS. 4 through 8 show sensor assemblies according to the prior art.

FIGS. 1 and 2 show a detailed illustration of the structure of a sensor assembly 1 having a detection element 2 composed of a material that can influence a magnetic field. Also present is a sensor 3 having a magnetic element 4 and a flat support 5, two standard reed switches 6 and 7 being mounted flanking the magnetic element 4. This structure is shown in a sectional view in FIG. 2, which shows that the support 5 together with the elements provided thereon (magnetic element 4 and reed switches 6 and 7) is encapsulated by a casing 8. Not shown, but present, are connections for the reed switches 6 and 7 that lead out of the casing 8 and that are connected, for example, via a cables to a plug for hooking up the sensor assembly 1. In this case the detection element 2 has, for example, a flat shape (other shapes also being possible), and may be connected to the object (not illustrated here) or a component thereof.

It is clear from FIGS. 1 and 2 that the sensor assembly 1 is designed for detecting a straight-line movement of an object (not illustrated) and has a very flat structure, the orientation of the detection element 2 and sensor 3 in parallel planes allowing the distance between these two parts 2, 3 to be kept very small.

FIG. 3 shows that, instead of the magnetic element 4, which in FIGS. 1 and 2 is a permanent magnet, an electromagnet may also be used. In addition, the magnet is shaped according to the application and the installation space. Alternately, the magnet may be designed as a sintered part, or as a highly filled plastic part or a plastic having magnetic properties.

Instead of the applications of the detectors designed as reed switches 6 and 7, the use of Hall sensors, magnetic resonance sensor assemblies, or the like may be considered as a replacement for the one or more reed switches.

When reed switches are used, the following specialized characteristics may also be realized:

Open or closed:

The detection element (a disk, for example) is juxtaposed with the sensor from the outset (reed switch open); at a sufficiently large spacing the detection element, or at a hole in the detection element (reed switch closed).

One possible variant of an output signal pattern for two reed switches and a magnetic element is as follows:

| | Position 1 | Position 2 | Position 3 | Position 4 |
|---|---|---|---|---|
| Reed switch 6 | Open | Open | Closed | Closed |
| Reed switch 7 | Closed | Open | Open | Closed |

Other patterns may be generated by coding of the detection element or by the choice of the starting position.

The switching response is determined by:
Shape (external) of the detection element, i.e. holes (coding) in the disk
Matching the reed and the magnet (sensitivity, magnet strength →hₘₐₓ, magnet shape)

Advantages:
Simple principle (reed as a break contact),
Depending on the position (switch), only two connections are necessary,.
No EMI/ESD protection necessary,
No polarity-reversal protection necessary,
Only the position, and not the polarity of the magnet, need be considered,
Output signal 0<Vₒᵤₜ<24V (100V),
Simple signal matching is possible (two resistors),
Enclosed design of the sensor assembly,
Extremely flat sensor assembly,
For very closely spaced succeeding positions (small distance or angle), one magnet between two switches is sufficient, resulting in a middle position in which both switches are closed or open.

The use of an electromagnet results in additional applications and advantages:
Function test or system check test at beginning of use (both magnetic switches must switch). Example: Ignition is switched on and an automobile is started. It is then necessary to switch on the electromagnet in the installed system and to also cycle the reed switches (magnetic switches), thus indicating that they are functional.
Safety applications may be implemented (for example, identification of open or short circuits, contact problems resulting from high transition resistances, and the like).

When the detection element does not have a flat shape, additional switch points may be generated by modifying the detection element, for example according to the following illustration:

[see source for diagram]

### LIST OF REFERENCE NUMERALS

1 Sensor assembly

2 Detection element

3 Sensor

4 Magnetic element

5 Support

6 Reed switch

7 Reed switch

8 Casing

1. A sensor assembly for detecting linear or rotary movement of an object, wherein a detection element fastened to the object or forming part of the object cooperates with at least one sensor, characterized in that at least one or multiple detectors extend parallel to a plane of movement next to a magnetic element that generates a magnetic field, and the detection element is composed of a material that influences the magnetic field.

2. The sensor assembly according to claim 1, characterized in that the detectors and the magnetic element are mounted on a preferably flat support and are protected from outside influences by a casing.

3. The sensor assembly according to claim 2, characterized in that the detection element preferably has a flat shape and can move relative to the detectors parallel to a plane.

4. The sensor assembly according to claim 1, characterized in that the detectors are designed as reed switches.

5. The sensor assembly according to claim 1, characterized in that the detectors are designed as Hall sensors.

6. The sensor assembly according to claim 1, characterized in that the detectors are designed as magnetic resonance sensor assemblies.

7. The sensor assembly according to claim 1, characterized in that the magnetic element that generates a magnetic field is a permanent magnet.

8. The sensor assembly according to claim 1, characterized in that the magnetic element that generates a magnetic field is an electromagnet.

9. The sensor assembly according to claim 1, characterized in that the magnetic element that generates a magnetic field is a plastic having magnetic properties.
